(19) United States
(12) Patent Application Publication
(10) Pub. No.: US 2002/0099838 A1
(43) Pub. Date: Jul. 25, 2002

(54) Method for allocating receive buffers to accommodate retransmission scheme in wireless computer networks

(76) Inventor: Donia Sebastian, Folsom, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/819,568

(22) Filed: Mar. 27, 2001

Related U.S. Application Data
(60) Provisional application No. 60/263,611, filed on Jan. 22, 2001.

(51) Int. Cl. G06F 15/16

(52) U.S. Cl. 709/230

(57) ABSTRACT

Data is transmitted over a communication channel in a computer network from a source network component to one or more destination network components. Thereafter, one or more acknowledgements are transmitted from one of the destination network components to the source network component; and different data, which may include retransmissions, from the previously transmitted data is transmitted from the source network component to the one or more destination network components. At one or more nodes of the computer network, buffers are allocated for the reception of packets made according to this scheme. Such allocation is dynamic in nature and varies according to the channel occupancy. That is, buffer space is allocated at the components of the network according to which traffic streams are currently utilizing the channel.

### RELATED APPLICATION

The present application is related to and hereby claims the priority benefit of U.S. patent application Ser. No. 09/614,928, entitled “Retransmission Scheme in Wireless Computer Networks” filed Jul. 12, 2000, by Rajugopal R. Gubbi and Donia Sebastian and U.S. patent application Ser. No. 09/614,309, entitled “Stream Connection Management in Wireless Computer Networks” filed Jul. 12, 2000 by Rajugopal R. Gubbi and Donia Sebastian.

### FIELD OF THE INVENTION

The present invention relates generally to a scheme for communications within a computer network and, in particular, to such communications as occur between nodes in such a network across a wireless link.

### BACKGROUND

Modern computer networks allow for inter-communication between a number of nodes such as personal computers, workstations, peripheral units and the like. Network links transport information between these nodes, which may sometimes be separated by large distances. However, to date most computer networks have relied on wired links to transport this information. Where wireless links are used, they have typically been components of a very large network, such as a wide area network, which may employ satellite communication links to interconnect network nodes separated by very large distances. In such cases, the transmission protocols used across the wireless links have generally been established by the service entities carrying the data being transmitted, for example, telephone companies and other service providers.

In the above-referenced co-pending patent application, which is assigned to the assignee of the present application and is incorporated herein by reference in its entirety, a computer network employing a digital wireless communication link was described. The architecture of that network included a number of network components arranged in a hierarchical, client-server fashion and communicatively coupled to one another through communication links operative at different levels of the hierarchy. At the highest level of the hierarchy, a communication protocol that supports dynamic addition of new network components at any level of the hierarchy according to bandwidth requirements within a communication channel operative at the highest level of the network hierarchy is used.

The generalization of this network structure is shown in FIG. 1. A subnet 10 includes a server 12. In this scheme, the term “subnet” is used to describe a cluster of network components that includes a server and several clients associated therewith (e.g., coupled through the wireless communication link). Depending on the context of the discussion however, a subnet may also refer to a network that includes a client and one or more subclients associated therewith. A “client” is a network node linked to the server through the wireless communication link. Examples of clients include audio/video equipment such as televisions, stereo components, personal computers, satellite television receivers, cable television distribution nodes, and other household appliances.

Server 12 may be a separate computer that controls the communication link, however, in other cases server 12 may be embodied as an add-on card or other component attached to a host computer (e.g., a personal computer) 13. Server 12 has an associated radio 14, which is used to couple server 12 wirelessly to the other nodes of subnet 10. The wireless link generally supports both high and low bandwidth data channels and a command channel. Here a channel is defined as the combination of a transmission frequency (more properly a transmission frequency band) and a pseudo-random (PN) code used in a spread spectrum communication scheme. In general, a number of available frequencies and PN codes may provide a number of available channels within subnet 10. As is described in the co-pending application cited above, servers and clients are capable of searching through the available channels to find a desirable channel over which to communicate with one another.

Also included in subnet 10 are a number of clients 16, some of which have shadow clients 18 associated therewith. A shadow client 18 is defined as a client which receives the same data input as its associated client 16 (either from server 12 or another client 16), but which exchanges commands with server 12 independently of its associated client 16. Each client 16 has an associated radio 14, which is used to communicate with server 12, and some clients 16 may have associated subclients 20. Subclients 20 may include keyboards, joysticks, remote control devices, multi-dimensional input devices, cursor control devices, display units and/or other input and/or output devices associated with a particular client 16. A client 16 and its associated subclients 20 may communicate with one another via communication links 21, which may be wireless (e.g., infra-red, ultrasonic, spread spectrum, etc.) communication links.

Each subnet 10 is arranged in a hierarchical fashion with various levels of the hierarchy corresponding to levels at which intra-network component communication occurs. At a highest level of the hierarchy exists the server 12 (and/or its associated host 13), which communicates with various clients 16 via the wireless radio channel. At other, lower levels of the hierarchy the clients 16 communicate with their various subclients 20 using communication links 21, for example, wired communication links or wireless communication links such as infrared links.

Where half-duplex radio communication is used on the wireless link between server 12 and clients 16, a communication protocol based on a slotted link structure with dynamic slot assignment is employed. Such a structure supports point-to-point connections within subnet 10 and slot sizes may be re-negotiated within a session. Thus a data link layer that supports the wireless communication can accommodate data packet handling, time management for packet transmission and slot synchronization, error correction coding (ECC), channel parameter measurement and channel switching. A higher level transport layer provides all necessary connection related services, policing for bandwidth utilization, low bandwidth data handling, data broadcast and, optionally, data encryption. The transport layer also allocates bandwidth to each client 16, continuously polices any under or over utilization of that bandwidth, and also accommodates any bandwidth renegotiations, as may be required whenever a new client 16 comes on-line or when one of the clients 16 (or an associated subclient 20) requires greater bandwidth.

The co-pending application also described a retransmission scheme for use within a wireless computer network wherein half-duplex radio communication is used. Such a retransmission scheme was styled as a continuous ARQ scheme with a selective repeat function, as illustrated in FIG. 2. As shown, within a network frame 52, various packets (designated by the use of numbers within square brackets in the illustration) may be transmitted from one node to another (e.g., from a server to a client) across the wireless communication link. The acknowledgements (ACK) 54 returned by the receiving node are grouped and transmitted, preferably as a command packet, in that node's transmission slot within a network frame. Included in that grouping may be positive acknowledgements (ACKs) and negative acknowledgements (NAKs). The negative acknowledgements are an indication that a packet was not received (e.g., packet 3 in the first network frame as shown in the illustration). The source node then retransmits the negatively acknowledged packets along with any new packets in the succeeding network frame 52.

In addition to the use of the continuous ARQ with selective repeat, the retransmission scheme also provided for multiple retransmissions per request, when channel bandwidth is available, and, as shown in FIG. 2, employed a grouped, window based acknowledgement mechanism.

To accommodate the use of the positive and negative acknowledgements discussed above, the transmitting node (node A in FIG. 2) stamps each packet in a stream with a sequence number. This way, the receiving node is able to respond with a positive/negative acknowledgement for a given packet. The acknowledgements are grouped to synchronize with the node's transmit slot and are transmitted as part of a command stream. For the example in FIG. 2, node A is transmitting packets to node B. The packet with sequence number 3 is lost in the first network frame 52 and hence is negatively acknowledged by node B. Accordingly, in the second network frame 52, node A retransmits pack [9 ] and then transmits new packets.

### SUMMARY OF THE INVENTION

In one embodiment, buffer space is allocated within nodes of a computer network according to communication channel utilization by one or more traffic streams within the network. Such allocation may be measured on the basis of the number of packets per frame per traffic stream. In some cases, the communication channel may be a wireless communication channel. In general, such allocation may be made for receive buffers and may also take into consideration the round trip delay time experienced within the network.

These and other features and advantages of the present invention will be apparent from a review of the detailed description and its accompanying drawings that follow.

### BRIEF DESCRIPTION OF THE DRAWINGS

The present invention is illustrated by way of example, and not limitation, in the figures of the accompanying drawings in which:

FIG. 1 illustrates a generalized network structure that is supported by a wireless communication protocol configured in accordance with an embodiment of the present invention;

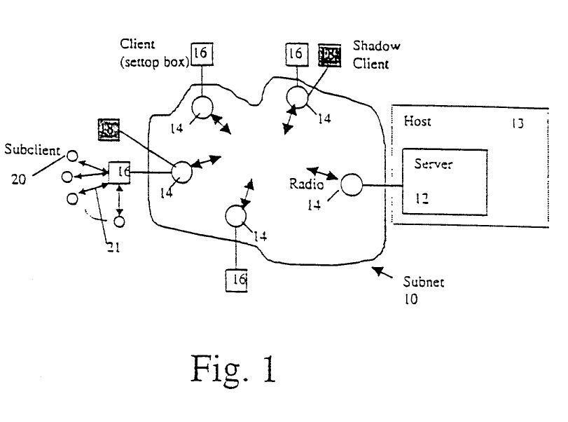

FIG. 2 illustrates a retransmission scheme employing grouped positive and negative acknowledgements for use in a computer network in accordance with one embodiment of the present invention;

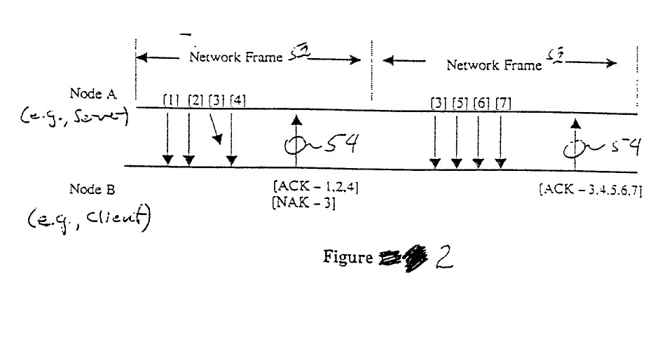

FIG. 3 illustrates a communication system having receive buffers which may be allocated to traffic streams according to one embodiment of the present invention;

### DETAILED DESCRIPTION

Described herein is scheme for allocating buffer space to allow for the retransmissions of data and/or commands within a wireless computer network or, indeed, in any computer network that uses a shared time division multiplexed communication channel. The present scheme is generally applicable to a variety of wireless network environments, but finds especially useful application in a computer network which is located in a home environment. Thus, in some cases the present scheme may be discussed with reference to the particular aspects of a home environment. However, this discussion should in no way be seen to limit the applicability of the present invention to other network environments and the broader spirit and scope of the present invention is recited in the claims which follow this discussion.

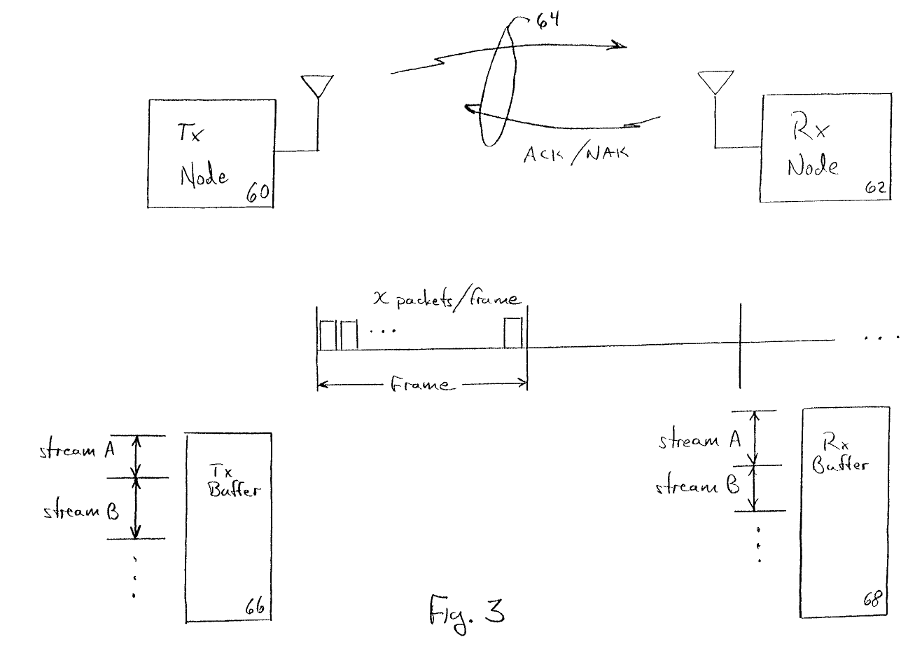

FIG. 3 illustrates the general case for a computer network having any number of nodes and a retransmission scheme similar to that discussed above. In this illustration, a transmitting node 60 and a receiving node 62 are show communicating across a wireless communication link 64. However, in general, it should be recognized that the communication link 64 could be any form of communication link whether wired or wireless or both. Located at transmitting node 60 is a transmit buffer 66. Located at receiving node 62 is a receive buffer 68. In general, these buffers may be made up of one or more physical memory devices such as random access memories (RAMs), flash memory devices, or other physical memory devices. These buffers 66 and 68 are used to store packets during the transmission and reception operations, respectively, within the network. Because of the delayed acknowledgement scheme used in the network, that is because acknowledgements are grouped and not transmitted individually in response to each packet sent by transmitting node 60, it is necessary that copies of packets which are transmitted and received be stored in some fashion so that lost packets can be identified and retransmissions thereof accommodated. Such lost packets may be identified by examining the sequence number of the received packets stored in receive buffer 68. All the received packets following a lost packet will remain buffered and will not be delivered to higher layers, untill either the lost packet is received or a timeout period expires.

Also shown in FIG. 3 is an illustration of the transmission scheme employed for the transmit node 60. Packets of various traffic streams are sent within frame periods. Within each frame there may, in general, be x packets, with a fraction of the x packets being associated with each of one or more traffic streams. This transmission scheme creates a challenge at the receiving node 62 in terms of how the physically limited size of receive buffer 68 should be allocated amongst various traffic streams A, B, etc.

One method, of course, would be to allocate a fixed size or a portion of the receive buffer 68 for each traffic stream. However, this approach is somewhat wasteful in that there may often be times when no traffic for a given stream is being transmitted by node 60. Also, if there is no packet loss for the stream, received packets need not be queued and buffers would be unused. If the number of receive buffers is low, the resulting transmit window must be shortened so as to ensure that no buffer overflows for any given stream occurs. This tends to reduce the overall thruput of the network, so that if other schemes exist they will be preferred over this hard allocation scheme.

In place of this hard allocation scheme, the present invention adopts a dynamic allocation approach where buffer space is allocated according to channel occupancy. That is, buffer space at receive node 62 is allocated according to which traffic streams have packets being transmitted in channel 64. When no traffic of a given stream is being transmitted, no space to that stream is allocated in receive buffer 68. Thus, the present scheme avoids wasting physical memory resources and, instead, provides buffer allocation only where it is needed.

The remaining question, then, is how to fairly allocate portions of the receive buffer 68 so that all streams with traffic in the channel 64 are accommodated. This allocation must be done with consideration to the round trip delay (RTD) time that is experienced in channel 64. In this case, the round trip delay includes the time needed for transmission from transmit node 60 through reception at receive node 62 and then an acknowledgement transmission from receive node 62 to transmit node 60.

If we consider that ‘N’ is the maximum number of packets that can be received in a network frame and RTD is the round trip delay expressed in units of network frame, the maximum number of total radio receive buffers required can be expressed as

Bmax>=N*2*RTD.

Assuming that a lost packet can be recovered in RTD slots retransmission, having enough to hold all the packets received in 2*RTD slots will guarantee that the transmit window limit will not be reached and traffic non-disrupted for any stream when the transmit window size is determined as below.

For arriving at the receive buffer requirements for a given stream, let ‘p’ be the maximum packets per network frame for a given stream. Then the number of receive buffers required for this stream ca be expressed as

Bs>=p*2*RTD

Bs number of receive buffers are not statically set aside for every stream. Instead, every stream is allowed to utilize Bs buffers out of the total pool of Bmax when there is a packet loss. The transmit window size for a stream is assigned to be the same as its Bs. Provided that the lost packets are recovered within 2*RTD, this would result in not blocking the transmit windows of any stream. In the above equations, the factor “2” could be replaced with any multiplier greater than 1.5 (which is used to account for a total round trip delay time). The multiplier 2 is preferred to allow for possible missed first retransmission attempts.

Thus, a buffer allocation scheme to accommodate a retransmission scheme for use in a wireless computer network has been described. Although discussed with reference to certain illustrated embodiments, the present invention should not be limited thereby. Instead, the present invention should only be measured in terms of the claims that follow.

What is claimed is:

1. A method, comprising allocating receive buffer space at nodes of a computer network according to communication channel utilization by one or more traffic streams within the network.

2. The method of claim 1 wherein communication channel utilization is measured on a packet per frame per traffic stream basis.

3. The method of claim 2 wherein the communication channel is a wireless communication channel.

4. The method of claim 2 wherein the communication channel comprises a shared time division multiplexed communication channel.

5. The method of claim 2 wherein the allocation is further made according to round trip delay time within the network.

6. The method of claim 2 wherein a transmit window size is determined according to the receive buffer space allocation.

7. The method of claim 1 wherein the receive buffer space allocation is based on a number of packets per frame per stream.
